(19) United States
(12) Patent Application Publication
(10) Pub. No.: US 2012/0313598 A1
(43) Pub. Date: Dec. 13, 2012

(54) SYSTEM THAT REGULATES OUTPUT VOLTAGE AND LOAD CURRENT

(76) Inventor: Ronald K. Arp, Ramona, CA (US)

(21) Appl. No.: 13/156,088

(22) Filed: Jun. 8, 2011

(51) Int. Cl. G05F 1/10

(52) U.S. Cl. 323/282

(57) ABSTRACT

A system including a first circuit, a second circuit, and a third circuit. The first circuit receives a supply voltage and a timer signal and is configured to provide an output voltage that is greater than the supply voltage. The second circuit receives the output voltage and enables an output current if the output voltage is sufficiently greater than the supply voltage. The third circuit detects the output current and is configured to provide a load current and a feedback current in response to the output current. The first circuit receives the feedback current and a feed back loop including the first circuit and the second circuit and the third circuit regulates the output voltage and the load current via the feedback current.

### BACKGROUND

Some displays, such as liquid crystal displays (LCDs), do not produce light themselves and need illumination in the form of ambient light or a special light source to produce a visible image. One type of special light source is a backlight that illuminates a display from the side or back of the display panel, as opposed to the front. Backlights are used in small displays to increase readability in low light conditions, and in computer displays and televisions to produce light in a manner similar to a cathode ray tube (CRT) display.

Some color graphics displays (CGDs) include light emitting diodes (LED's) as backlights. Usually, CGDs that are three inches or smaller diagonally include one or two white LED's that can be run from a five volt power supply. However, larger CGDs often include a long string of LEDs that operate from a higher drive voltage, such as a series of 10 LEDs that operate from a 34 volt supply voltage.

Typically, a high voltage power supply provides the voltage needed by a larger CGD. This high voltage power supply can be a regular system supply or a dedicated voltage generator. The high voltage power supply provides power to a current source that drives the backlight LEDs. One type of high voltage power supply includes a switching boost circuit.

### BRIEF DESCRIPTION OF THE DRAWINGS

FIG. 1 is a diagram illustrating one embodiment of a system that includes a display, a backlight, and a power supply circuit.

FIG. 2 is a diagram illustrating one embodiment of a power supply circuit attached to a load.

FIG. 3 is a diagram illustrating one embodiment of a charge pump circuit.

FIG. 4 is a diagram illustrating one embodiment of an enable circuit, a feedback circuit, and a load.

FIG. 5 is a graph illustrating the operation of one embodiment of a power supply circuit.

### DETAILED DESCRIPTION

In the following detailed description, reference is made to the accompanying drawings which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In some systems, a high voltage power supply may be a regular system supply or a dedicated voltage generator, which can be cost prohibitive. Also, a high voltage power supply can include a switching boost circuit that operates at high frequencies, such as one megahertz, which causes electro-magnetic compatibility (EMC) issues due to fast switching transients. Also, a high voltage power supply generates enough voltage to run a worst case display, which can waste power when used with other, non-worst case displays. In addition, a high voltage power supply often has no way of limiting current in the case of a short on the output, such that the current regulator circuit has enough power handling capability to handle this condition, which implies larger transistors and resistors in the output of the current source and increased costs. Embodiments of a power supply circuit that do not have these problems are described herein.

FIG. 1 is a diagram illustrating one embodiment of a system 20 that includes a display 22, a backlight 24, and a power supply circuit 26. System 20 can be used in any suitable application/system, including user interfaces, computer systems, mobile computing devices, and telecommunication devices. In each application/system, system 20 is coupled to other circuits, such as a controller or micro-controller and an application/system power supply (not shown for clarity).

Display 22 provides information or graphics on a screen. Display 22 does not produce its own light. Instead, backlight 24 illuminates display 22. In one embodiment, display 22 is illuminated via at least one other light source, such as ambient light. In one embodiment, display 22 is an LCD. In one embodiment, display 22 is a CGD.

Backlight 24 illuminates display 22 to produce a visible image on the screen. In one embodiment, backlight 24 illuminates display 22 from the back of display 22. In one embodiment, backlight 24 illuminates display 22 from the side of display 22. In one embodiment, backlight 24 includes a series of LEDs. In one embodiment, backlight 24 includes a string of LEDs that operate from a high drive voltage, such as a series of 10 LEDs that operate from a 34 volt supply voltage.

Power supply circuit 26 is configured to provide a substantially constant load current to backlight 24. Power supply circuit 26 receives a timer signal and an application/system power supply voltage from the application/system. Power supply circuit 26 provides the load current in response to clocking the timer signal. In one embodiment, power supply circuit 26 receives a timer signal from a timer pin of a controller or a micro-controller in the application/system.

Power supply circuit 26 provides an output voltage that is greater than the application/system power supply voltage and greater than the drive voltage of backlight 24. If the drive voltage of backlight 24 is sufficiently less than the application/system power supply voltage, power supply circuit 26 pumps the output voltage to a voltage value that is greater than the application/system power supply voltage, which biases a transistor into the active region and enables the load current. If the drive voltage of backlight 24 is greater than the application/system power supply voltage, power supply circuit 26 pumps the output voltage to a voltage value that is greater than the application/system power supply voltage and that saturates the transistor and enables the load current.

Power supply circuit 26 includes a feedback loop that regulates the output voltage and the load current via a feedback current. Also, if the load current is shorted to a low voltage, such as ground, power supply circuit 26 prevents the output voltage from exceeding the application/system power supply voltage, which disables the load current.

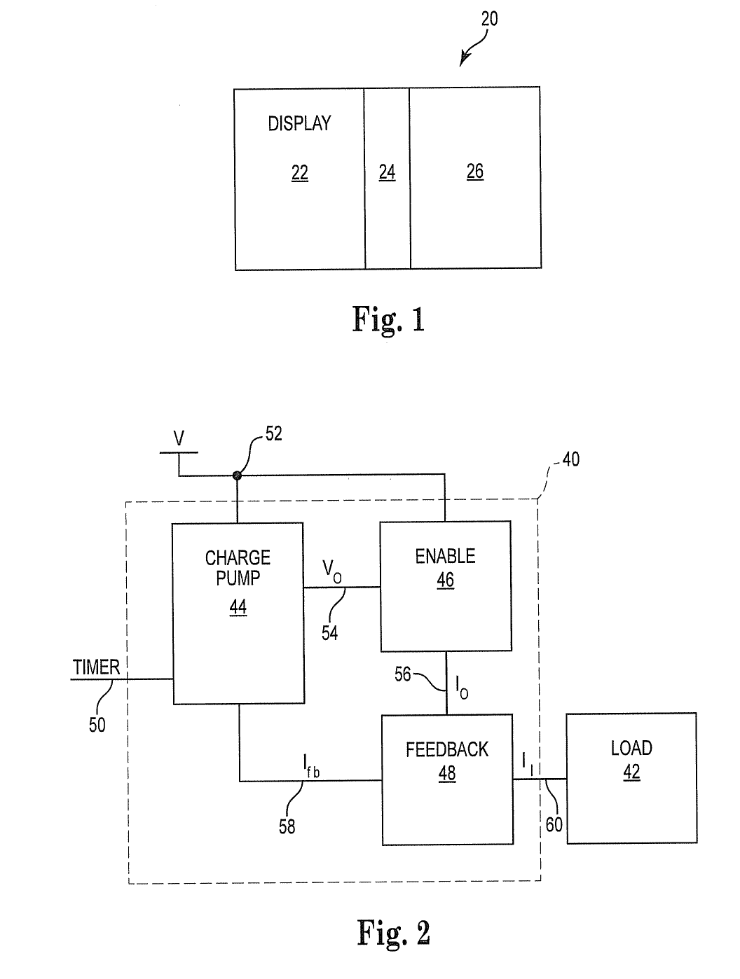

FIG. 2 is a diagram illustrating one embodiment of a power supply circuit 40 that is attached to a load 42. Power supply circuit 40 is configured to provide a substantially constant load current to load 42. Power supply circuit 40 is similar to power supply circuit 26 (shown in FIG. 1). In one embodiment, power supply circuit 40 is the same as power supply circuit 26 and load 42 is the same as backlight 24. In one embodiment, load 42 includes a series of LEDs. In one embodiment, load 42 includes a string of LEDs that operate from a high drive voltage, such as a series of 10 LEDs that operate from a 34 volt supply voltage.

Power supply circuit 40 can be used in any suitable application/system, including user interfaces, computer systems, mobile computing devices, and telecommunication devices. In each application/system, power supply circuit 40 is coupled to other circuits, such as a controller or micro-controller and an application/system power supply (not shown for clarity).

Power supply circuit 40 includes a charge pump circuit 44, an enable circuit 46, and a feedback circuit 48. Charge pump circuit 44 receives timer signal TIMER at 50 and an application/system power supply voltage V at 52, from the application/system. Charge pump circuit 44 is electrically coupled to enable circuit 46 via output voltage path 54. Enable circuit 46 receives the application/system power supply voltage V at 52 from the application/system and output voltage Vo at 54 from charge pump circuit 44. Enable circuit 46 is electrically coupled to feedback circuit 48 via output current path 56. Feedback circuit 48 receives output current Io at 56 from enable circuit 46. Feedback circuit 48 is electrically coupled to charge pump circuit 44 via feedback current path 58 and electrically coupled to load 42 via load current path 60. Charge pump circuit 44 receives feedback current Ifb at 58 and load 42 receives load current Il at 60. In one embodiment, charge pump circuit 44 is electrically coupled to a timer pin of a controller or a micro-controller in the application/system and charge pump circuit 44 receives the timer signal TIMER at 50 from the timer pin of the controller or micro-controller in the application/system.

Charge pump circuit 44 provides output voltage Vo at 54. If timer signal TIMER at 50 is held at a high voltage, such as 3 volts, charge pump circuit 44 provides an output voltage Vo that is substantially equal to the application/system power supply voltage V at 52. In response to clocking timer signal TIMER at 50, charge pump circuit 44 pumps output voltage Vo at 54 to a voltage value that is greater than the application/system power supply voltage V at 52. Charge pump circuit 44 receives feedback current Ifb at 58 from feedback circuit 48 to regulate output voltage Vo at 54.

Enable circuit 46 provides output current Io at 56. Enable circuit 46 receives the application/system power supply voltage V at 52 and output voltage Vo at 54. If output voltage Vo at 54 is less than or equal to the application/system power supply voltage V at 52, enable circuit 46 disables output current Io at 56, such that no output current Io flows at 56. If output voltage Vo at 54 is sufficiently greater than the application/system power supply voltage V at 52, enable circuit 46 enables output current Io at 56, such that output current Io flows at 56. In one embodiment, the value of the sufficiently greater voltage is equal to the turn on voltage of a transistor. In one embodiment, the voltage value of a sufficiently greater voltage is equal to the voltage for forward biasing a pn junction.

Feedback circuit 48 detects output current Io at 56 and provides feedback current Ifb at 58 and load current Il at 60. If output current Io at 56 is disabled, feedback circuit 48 does not provide a feedback current Ifb at 58 or a load current Il at 60. If output current Io at 56 is enabled, feedback circuit 48 detects output current Io at 56 and provides load current Il at 60. As load current Il at 60 approaches a substantially constant load current value, feedback circuit 48 provides feedback current Ifb at 58 to charge pump circuit 44.

In a feedback loop, charge pump circuit 44 receives feedback current Ifb at 58 and regulates output voltage Vo at 54 via feedback current Ifb at 58. Enable circuit 46 receives output voltage Vo at 54 and regulates output current Io at 56 based on output voltage Vo at 54. Feedback circuit 48 detects output current Io at 56 and provides feedback current Ifb at 58 and a substantially constant load current Il at 60. Feedback circuit 48 increases feedback current Ifb at 58 in response to an increase in output current Io at 56 and feedback circuit 48 decreases feedback current Ifb at 58 in response to a decrease in output current Io at 56.

Load 42 receives load current Il at 60. In one embodiment, load 42 is a backlight such that load 42 provides illumination to a display in response to receiving load current Il at 60.

In operation, if timer signal TIMER at 50 is held at a high voltage, charge pump circuit 44 provides an output voltage Vo that is substantially equal to the application/system power supply voltage V at 52. With output voltage Vo at 54 less than or equal to the application/system power supply voltage V at 52, enable circuit 46 disables output current Io at 56 and feedback circuit 48 does not provide a feedback current Ifb at 58 or a load current Il at 60.

If timer signal TIMER at 50 is clocked, charge pump circuit 44 pumps output voltage Vo at 54 to a voltage value that is greater than the application/system power supply voltage V at 52. As output voltage Vo at 54 is pumped to a sufficiently greater voltage value than the application/system power supply voltage V at 52, enable circuit 46 enables output current Io at 56 and feedback circuit 48 provides load current Il at 60. As load current Il at 60 approaches a substantially constant load current value, feedback circuit 48 provides feedback current Ifb at 58. Charge pump circuit 44 receives feedback current Ifb at 58 and regulates output voltage Vo at 54 and enable circuit 46 receives output voltage Vo at 54 and regulates output current Io at 56. Feedback circuit 48 continues providing feedback current Ifb at 58 and load current Il at 60, and load 42 receives load current Il at 60. Timer signal TIMER at 50 is held high to shut off load current Il at 60.

Also, if load current Il at 60 is shorted to a low voltage, such as ground, feedback circuit 48 prevents charge pump circuit 44 from pumping output voltage Vo at 54 to a voltage value that is greater than application/system power supply voltage V at 52. With output voltage Vo at 54 less than or equal to the application/system power supply voltage V at 52, enable circuit 46 disables output current Io at 56, such that no output current Io flows at 56.

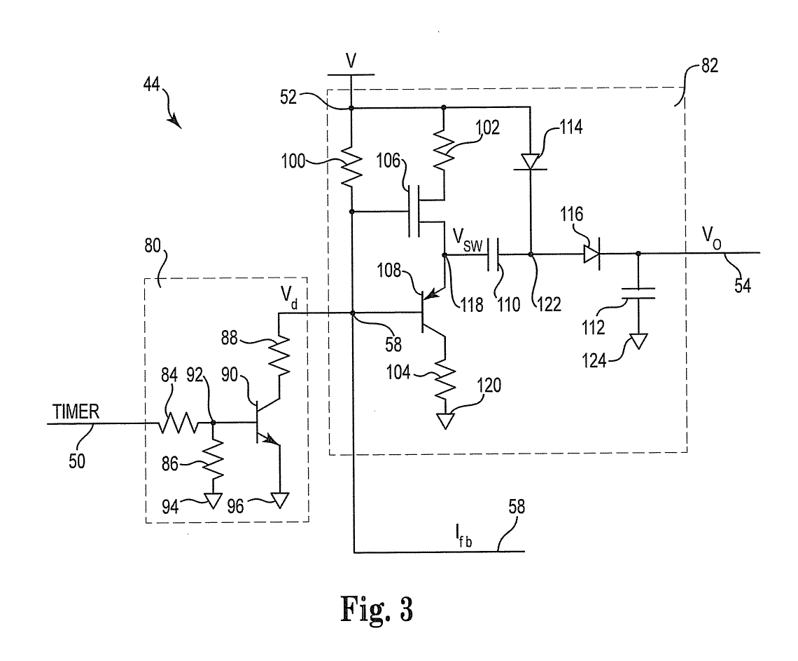

FIG. 3 is a diagram illustrating one embodiment of charge pump circuit 44 in power supply circuit 40 (shown in FIG. 2). Charge pump circuit 44 includes a charge pump driver circuit 80 and a push/pull charge pump circuit 82. Charge pump driver circuit 80 is electrically coupled to push/pull charge pump circuit 82 and to feedback circuit 48 (shown in FIG. 2) via feedback current path 58. Charge pump driver circuit 80 receives timer signal TIMER at 50 and provides driver voltage Vd at 58. Push/pull charge pump circuit 82 is electrically coupled to enable circuit 46 (shown in FIG. 2) via output voltage path 54 and to application/system power supply voltage V at 52. Push/pull charge pump circuit 82 receives application/system power supply voltage V at 52 and driver voltage Vd at 58 and provides output voltage Vo at 54.

In operation, if timer signal TIMER at 50 is held at a high voltage level, such as 3 volts, charge pump driver circuit 80 provides driver voltage Vd at 58 at a low voltage value and push/pull charge pump circuit 82 is deactivated or shut off, such that output voltage Vo at 54 is not pumped to a higher voltage value. If timer signal TIMER at 50 is continuously clocked between high and low voltage levels, such as 3 and 0 volts, charge pump driver circuit 80 clocks driver voltage Vd at 58 between low and high voltage values and push/pull charge pump circuit 82 is activated to pump output voltage Vo at 54 to a higher voltage value.

Charge pump driver circuit 80 includes resistor 84, resistor 86, resistor 88, and a driver transistor 90. Driver transistor 90 is an npn bipolar junction transistor. In other embodiments, driver transistor 90 can be another transistor, such as a pnp bipolar junction transistor or a metal oxide semiconductor field effect transistor (MOSFET).

One end of resistor 84 receives timer signal TIMER at 50 and the other end of resistor 84 is electrically coupled to one end of resistor 86 and the base of driver transistor 90 via driver transistor base path 92. The other end of resistor 86 is electrically coupled to a reference, such as ground, at 94. The collector of driver transistor 90 is electrically coupled to one end of resistor 88 and the emitter of driver transistor 90 is electrically coupled to a reference, such as ground, at 96. The other end of resistor 88 is electrically coupled to push/pull charge pump circuit 82 via feedback current path 58 and provides driver voltage Vd at 58.

In operation, if timer signal TIMER at 50 is held at a high voltage level, driver transistor 90 is turned on and pulls driver voltage Vd at 58 to a low voltage value through resistor 88. In one embodiment, if timer signal TIMER at 50 is held at a high voltage level, driver transistor 90 is saturated.

If timer signal TIMER at 50 is continuously clocked between high and low voltage levels, driver transistor 90 is alternately turned on and off to clock driver voltage Vd at 58 between low and high voltage values. If charge pump driver circuit 80 receives feedback current Ifb at 58, driver transistor 90 sinks feedback current Ifb at 58 through resistor 88, which pulls the low voltage value of driver voltage Vd at 58 to a higher voltage value than the value provided without sinking feedback current Ifb at 58. In one embodiment, timer signal TIMER at 50 is clocked at about 100 kilo-hertz.

Push/pull charge pump circuit 82 includes resistor 100, resistor 102, resistor 104, push/pull transistor 106, push/pull transistor 108, capacitor 110, capacitor 112, diode 114, and diode 116. Push/pull transistor 106 is an n-channel MOSFET and push/pull transistor 108 is a pnp bipolar junction transistor. In one embodiment, diode 114 is a schottky diode. In one embodiment, diode is a schottky diode. In other embodiments, push/pull transistor 106 can be another transistor, such as a p-channel MOSFET or a bipolar junction transistor, and push/pull transistor 108 can be another transistor, such as an npn bipolar junction transistor or a MOSFET.

One end of resistor 100 is electrically coupled to application/system power supply voltage V at 52 and the other end of resistor 100 is electrically coupled to the gate of push/pull transistor 106, the base of push/pull transistor 108, charge pump driver circuit 80 and resistor 88, and feedback circuit 48 via feedback current path 58. One end of resistor 102 is electrically coupled to application/system power supply voltage V at 52 and the other end of resistor 102 is electrically coupled to one end of the drain-source path of push/pull transistor 106. The other end of the drain-source path of push/pull transistor 106 is electrically coupled to the emitter of push/pull transistor 108 and one side of capacitor 110 via switching voltage path 118. The collector of push/pull transistor 108 is electrically coupled to one end of resistor 104 and the other end of resistor 104 is electrically coupled to a reference, such as ground, at 120. One end of diode 114 is electrically coupled to application/system power supply voltage V at 52 and the other end of diode 114 is electrically coupled to the other side of capacitor 110 and one end of diode 116 via internal path 122. The other end of diode 116 is electrically coupled to one side of capacitor 112 and to enable circuit 46 (shown in FIG. 2) via output voltage path 54. The other side of capacitor 112 is electrically coupled to a reference, such as ground, at 124.

In operation, if timer signal TIMER at 50 is held at a high voltage level, driver transistor 90 is turned on to pull driver voltage Vd at 58 to a low voltage value. This biases push/pull transistor 106 off and push/pull transistor 108 on, which pulls switching voltage Vsw at 118 to a low voltage value. Capacitor 110 is charged via diode 114 and output voltage Vo at 54 is pulled to about the application/system power supply voltage V at 52.

If timer signal TIMER at 50 is continuously clocked between high and low voltage levels, driver transistor 90 is alternately turned on and off to clock driver voltage Vd at 58 between low and high voltage values. With timer signal TIMER at 50 at a high voltage level, driver transistor 90 is turned on to pull driver voltage Vd at 58 to a low voltage value, which biases push/pull transistor 106 off and push/pull transistor 108 on. This pulls switching voltage Vsw at 118 to a low voltage value. Capacitor 110 charges at internal path 122 toward application/system power supply voltage V at 52 via diode 114. Output voltage Vo at 54 is initially at about the application/system power supply voltage V at 52. With timer signal TIMER at 50 at a low voltage level, driver transistor 90 is turned off and driver voltage Vd at 58 is pulled to a high voltage value through resistor 100. This biases push/pull transistor 106 on and push/pull transistor 108 off, such that push/pull transistor 106 pulls switching voltage Vsw at 118 to a high voltage value through resistor 102. Pulling switching voltage Vsw at 118 to a high voltage value discharges capacitor 118 at internal path 122 through diode 116 to capacitor 112 and output voltage Vo at 54, pumping output voltage Vo at 54 to a higher voltage value. Clocking timer signal TIMER at 50 back and forth between the high voltage level and the low voltage level repeats the process and pumps output voltage Vo at 54 to a higher voltage value or maintains output voltage Vo at 54 at a voltage value.

Output voltage Vo at 54 is regulated via feedback current Ifb at 58. If charge pump driver circuit 80 receives feedback current Ifb at 58, driver transistor 90 sinks feedback current Ifb at 58 through resistor 88, which pulls the low voltage value of driver voltage Vd at 58 to a higher low voltage value. Push/pull transistor 108 is not biased on as strongly by the higher low voltage value of driver voltage Vd at 58 and switching voltage Vsw is not pulled as low by push/pull transistor 108 during the cycle. This results in capacitor 110 charging to a lower voltage value across capacitor 110, such that when driver voltage Vd at 58 is pulled to a high voltage value and capacitor 110 discharges through diode 116 to capacitor 112, the amount of charge transferred to capacitor 112 is smaller and the increase in output voltage Vo at 54 is smaller. Thus, an increase in feedback current Ifb at 58 decreases the charge pumped into capacitor 112 and a decrease in feedback current Ifb at 58 increases the charge pumped into capacitor 112, regulating output voltage Vo at 54.

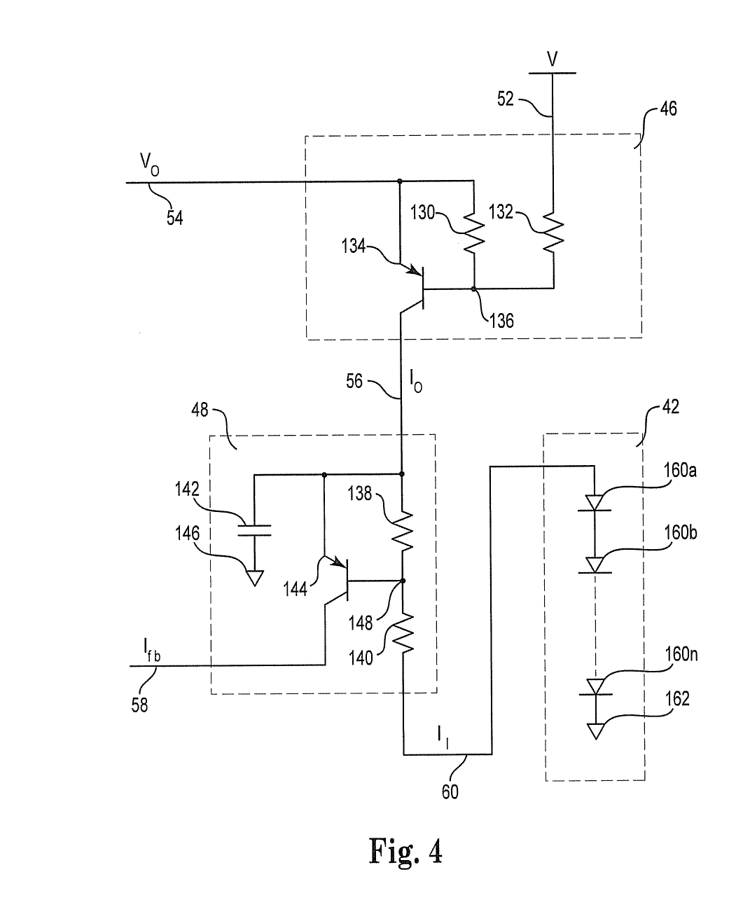

FIG. 4 is a diagram illustrating one embodiment of enable circuit 46, feedback circuit 48, and load 42 (all shown in FIG. 2). Enable circuit 46 is electrically coupled to application/system power supply voltage V at 52, to charge pump circuit 44 including push/pull charge pump circuit 82 (shown in FIG. 3) via output voltage path 54, and to feedback circuit 48 via output current path 56. Enable circuit 46 receives application/system power supply voltage V at 52 and output voltage Vo at 54 and provides output current Io at 56. Feedback circuit 48 is electrically coupled to charge pump circuit 44 including charge pump driver circuit 80 and push/pull charge pump circuit 82 (shown in FIG. 3) via feedback current path 58 and to load 42 via load current path 60. Feedback circuit 48 receives output current Io at 56 and provides feedback current Ifb at 58 and load current Il at 60. Load 42 receives load current Il at 60 and provides illumination.

In operation, with timer signal TIMER at 50 held at a high voltage and output voltage Vo at 54 less than or equal to application/system power supply voltage V at 52, enable circuit 46 disables output current Io at 56 and feedback circuit 48 does not provide a feedback current Ifb at 58 or a load current Il at 60. If timer signal TIMER at 50 is clocked, charge pump circuit 44 pumps output voltage Vo at 54 to a higher voltage value. As output voltage Vo at 54 is pumped to a sufficiently greater voltage value than the application/system power supply voltage V at 52, enable circuit 46 enables output current Io at 56 and feedback circuit 48 provides load current Il at 60. As load current Il at 60 increases to a substantially constant load current value, feedback circuit 48 provides feedback current Ifb at 58 to charge pump circuit 44 to regulate output voltage Vo at 54 and output current Io at 56. Load 42 receives load current Il at 60 and provides illumination. Timer signal TIMER at 50 is held high to shut off load current Il at 60.

Enable circuit 46 includes resistor 130, resistor 132, and enable transistor 134. Enable transistor 134 is a pnp bipolar junction transistor. In other embodiments, enable transistor 134 can be another transistor, such as an npn bipolar junction transistor or a MOSFET.

One end of resistor 130 is electrically coupled to the emitter of enable transistor 134 and charge pump circuit 44 of FIG. 3 via output voltage path 54. The emitter of enable transistor 134 and resistor 130 receive output voltage Vo at 54. The other end of resistor 130 is electrically coupled to the base of enable transistor 134 and one end of resistor 132 via base path 136. The other end of resistor 132 is electrically coupled to application/system power supply voltage V at 52. The collector of enable transistor 134 is electrically coupled to feedback circuit 48 via output current path 56.

In operation, if output voltage Vo at 54 is less than application/system power supply voltage V at 52, the base-emitter junction of enable transistor is reverse biased and enable transistor 134 is biased off. This disables output current Io at 56, such that no output current Io at 56 flows through enable transistor 134. If timer signal TIMER at 50 is clocked, charge pump circuit 44 pumps output voltage Vo at 54 to a higher voltage value and as output voltage Vo at 54 is pumped to a sufficiently high voltage value that is greater than the application/system power supply voltage V at 52, the base-emitter junction of enable transistor 134 is forward biased and enable transistor 134 is biased on to enable output current Io at 56. Enable transistor 134 provides a larger output current Io at 56 as output voltage Vo at 54 is pumped to a higher voltage value.

Feedback circuit 48 includes resistor 138, resistor 140, capacitor 142, and transistor 144. Transistor 144 is a pnp bipolar junction transistor. In other embodiments, transistor 144 can be another transistor, such as an npn bipolar junction transistor or a MOSFET.

One end of resistor 138 is electrically coupled to the emitter of transistor 144 and to one side of capacitor 142 via output current path 56. The emitter of transistor 144, capacitor 142, and resistor 138 receive output current Io at 56. The other side of capacitor 142 is electrically coupled to a reference, such as ground, at 146. The other end of resistor 138 is electrically coupled to the base of transistor 144 and to one end of resistor 140 via base path 148. The other end of resistor 140 is electrically coupled to load 42 via load current path 60 and the collector of transistor 144 is electrically coupled to charge pump circuit 44 via feedback current path 58.

In operation, if enable circuit 46 disables output current Io at 56, the base-emitter junction of transistor 144 is not forward biased and transistor 144 is biased off, such that feedback circuit 48 does not provide a feedback current Ifb at 58 or a load current Il at 60. If timer signal TIMER at 50 is clocked, charge pump circuit 44 pumps output voltage Vo at 54 to a higher voltage value and enable transistor 134 is biased on to provide output current Io at 56.

Feedback circuit 48 detects output current Io at 56 and provides load current Il at 60 and feedback current Ifb at 58. Output current Io at 56 flows through resistor 138 and resistor 140 to provide load current Il at 60. As output voltage Vo at 54 increases, output current Io at 56 increases and the voltage across resistor 138 increases to forward bias the base-emitter junction of transistor 144. Transistor 144 is biased on to provide feedback current at 58. Charge pump circuit 44 of FIG. 2 receives feedback current Ifb at 58, which regulates output voltage Vo at 54 and output current Io at 56 and load current Il at 60.

Also, if load current Il at 60 is shorted to a low voltage, such as ground, driver voltage Vd at 58 forward biases the base-collector junction of transistor 144. Current flows through the base-collector junction of transistor 144 and resistor 140 to ground, which clamps the driver voltage Vd at 58 to a voltage value that prevents push/pull charge pump circuit 82 from switching and pumping output voltage Vo at 54 to a higher voltage value. Switching voltage Vsw at 118 in push/pull charge pump circuit 82 is held low and prevented from switching. When output voltage Vo at 54 is less than or equal to the application/system power supply voltage V at 52, enable circuit 46 disables output current Io at 56, such that no output current Io at 56 flows.

Load 42 is a string or series of “n” LEDs 160a, 160b . . . 160n that are used for illuminating a device, such as display 22 (shown in FIG. 1). LED 160a is electrically coupled to feedback circuit 48 and resistor 140 via load current path 60 and to LED 160b, which is electrically coupled to the next LED in the series, and so on to LED 160n. The other side of LED 160n is electrically coupled to a reference, such as ground, at 162. Load 42 has a drive voltage provided by output voltage Vo at 54. LEDs 160a, 160b . . . 160n receive load current Il at 60 and provide illumination. In one embodiment, load 42 includes a string of 8 or more LEDs. In one embodiment, load 42 includes a string of LEDs that operate from a high drive voltage, such as a series of 10 LEDs that operate from a 34 volt supply voltage.

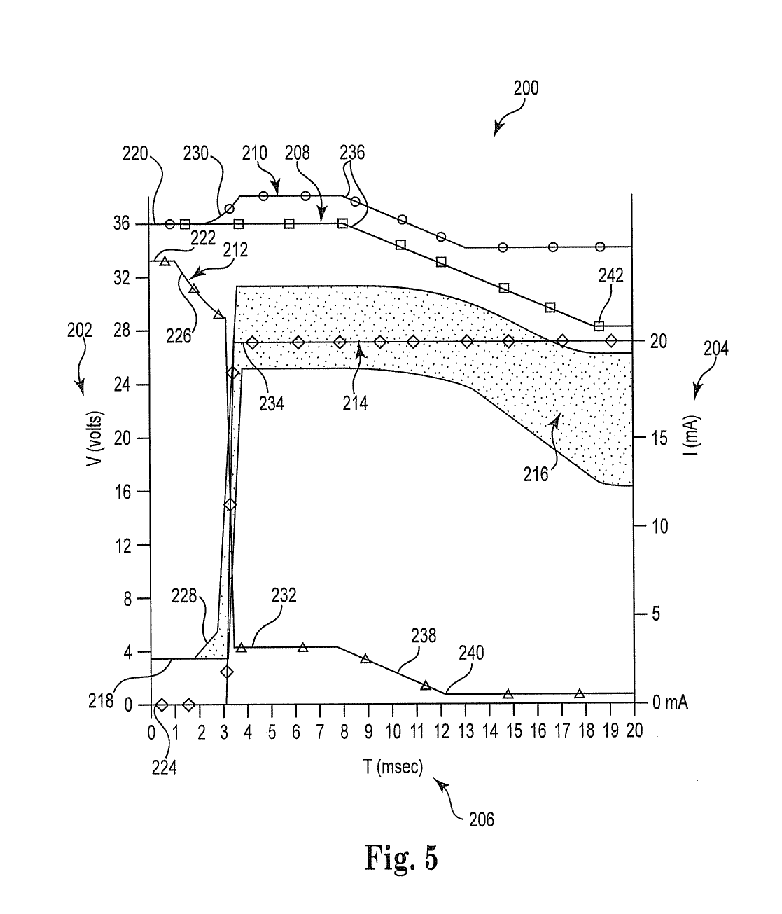

FIG. 5 is a graph 200 illustrating the operation of one embodiment of power supply circuit 40 (shown in FIG. 2). Graph 200 shows voltage values V in volts along the left vertical axis at 202, current values I in mA along the right vertical axis at 204, and time in milli-seconds (msec) along the horizontal axis at 206. The application/system power supply voltage V at 52 is graphed at 208, output voltage Vo at 54 is graphed at 210, the voltage across transistor 134 from emitter to collector is graphed at 212 and referred to herein as the transistor voltage at 212, and load current Il at 60 is graphed at 214. Switching voltage Vsw at 118 is graphed at 216, where shading indicates switching between the top and bottom limits of the shaded area.

In this example, the application/system power supply voltage V at 208 is initially 36 volts and ramped down to 28 volts over time. The forward voltage or drive voltage of load 42 is less than 36 volts, but greater than 28 volts. If the drive voltage of load 42 is less than the application/system power supply voltage V at 208, power supply circuit 40 pumps output voltage Vo at 210 just high enough to bias transistor 134 into the active region and enable output current Io at 56 and maintain 20 milli-amps (mA) of load current Il at 214. If the drive voltage of load 42 is greater than the application/system power supply voltage V at 208, power supply circuit 40 pumps output voltage Vo at 210 high enough to saturate transistor 134 and enable output current Io at 56, where feedback circuit 48 regulates output voltage Vo at 210 and maintains 20 milli-amps (mA) of load current Il at 214.

From time 0 to 1 msec, timer signal TIMER at 50 is held at a high voltage level that turns on driver transistor 90 and pulls driver voltage Vd at 58 to a low voltage value. This biases push/pull transistor 106 off and push/pull transistor 108 on, which pulls switching voltage Vsw at 216 to a low voltage value of 3 volts at 218. Capacitor 110 is charged via diode 114 and output voltage Vo at 210 is pulled to the application/system power supply voltage V at 208 of 36 volts at 220. With output voltage Vo at 210 equal to application/system power supply voltage V at 52, enable transistor 134 is biased off and output current Io at 56 is disabled, such that 0 mA of output current Io at 56 flows through enable transistor 134. At 222, the transistor voltage at 212 is 33 volts and transistor 144 is biased off, such that feedback circuit 48 does not provide a feedback current Ifb at 58. Also, at 224, load current Il at 214 is 0 mA.

At 1 msec, timer signal TIMER at 50 is continuously clocked between high and low voltage levels, which continuously switches driver voltage Vd at 58 between low and high voltage values. When driver voltage Vd at 58 is at a high voltage value, output current path 56 is charged to a higher voltage via current through the forward biased base-collector junction of transistor 144 and resistor 138. At 226, transistor voltage at 212 drops as output current path 56 is charged to a higher voltage. In one embodiment, timer signal TIMER at 50 is clocked at about 100 kilo-hertz.

With timer signal TIMER at 50 at a high voltage level, driver transistor 90 is turned on to pull driver voltage Vd at 58 to a low voltage value, which biases push/pull transistor 106 off and push/pull transistor 108 on. This pulls switching voltage Vsw at 216 to a low voltage value and capacitor 110 charges toward application/system power supply voltage V at 208 via diode 114. With timer signal TIMER at 50 at a low voltage level, driver transistor 90 is turned off and driver voltage Vd at 58 is pulled to a high voltage value, which biases push/pull transistor 106 on and push/pull transistor 108 off. This pulls switching voltage Vsw at 216 to a high voltage value that discharges capacitor 118 through diode 116 to capacitor 112 and output voltage Vo at 210.

At about 2 msec, at 228, switching voltage Vsw at 216 begins to show this high/low voltage swing and, at 230, output voltage Vo at 210 increases to a higher voltage value. Continuously clocking timer signal TIMER at 50 between the high voltage level and the low voltage level repeats this process and pumps output voltage Vo at 210 to a higher voltage value.

At about 3 msec, output voltage Vo at 210 is sufficiently greater than application/system power supply voltage V at 208 to forward bias the base-emitter junction of enable transistor 134, which turns on enable transistor 134 and provides output current Io at 56. The transistor voltage 212 drops to about 4 volts at 232 and load current Il at 214 increases to about 20 mA at 234. With the drive voltage of load 42 less than application/system power supply voltage V at 208 and with output voltage Vo at 210 pumped just high enough to forward bias the base-emitter junction of enable transistor 134, enable transistor 134 is biased into the active region. This enables output current Io at 56 and maintains about 20 milli-amps (mA) of load current Il at 214.

Feedback circuit 48 detects output current Io at 56 and provides load current Il at 214 and feedback current Ifb at 58. Output current Io at 56 flows through resistor 138 and resistor 140 to provide load current Il at 214. As output current Io at 56 increases, the voltage across resistor 138 increases to forward bias the base-emitter junction of transistor 144. Charge pump circuit 44 receives feedback current Ifb at 58, which regulates output voltage Vo at 210 and output current Io at 56 and load current Il at 214.

From about 3 to 8 msec, switching voltage Vsw at 216 switches between a low voltage value of about 25 volts and a high voltage value of about 31 volts. Charge pump circuit 44 continues to pump output voltage Vo at 210 to a voltage value that forward biases the base-emitter junction of transistor 144 and maintains about 20 milli-amps (mA) of load current Il at 214.

At about 8 msec, at 236, application/system power supply voltage V at 208 is ramped down. Charge pump circuit 44 continues to pump output voltage Vo at 210 to a voltage value that forward biases the base-emitter junction of transistor 144 and maintains about 20 milli-amps (mA) of load current Il at 214. Output voltage Vo at 210 ramps down, following application/system power supply voltage V at 208. Also, at 238, the transistor voltage at 212 ramps down, following output voltage Vo at 210 and application/system power supply voltage V at 208.

At about 12.5 msec, at 240, the transistor voltage at 212 has reached a minimum voltage value and enable transistor 134 is saturated. Application/system power supply voltage V at 208 is less than the drive voltage of load 42 and output voltage Vo at 210 is high enough to forward bias the base-emitter junction of transistor 134 and saturate transistor 134. Feedback circuit 48 provides feedback current Ifb at 58 and charge pump circuit 44 receives feedback current Ifb at 58 to regulate output voltage Vo at 210 and maintain 20 mA of load current Il at 214.

From about 12.5 to 18 msec, application/system power supply voltage V at 208 ramps down to 28 volts at 242. Charge pump circuit 44 pumps output voltage Vo at 210 to a substantially constant voltage of about 34 volts. Also, during this time, feedback circuit 48 and feedback transistor 144 reduce feedback current Ifb at 56, which increases the voltage swing of switching voltage Vsw at 216.

From 18 to 20 msec, application/system power supply voltage V at 208 remains constant at 28 volts. Charge pump circuit 44 pumps output voltage Vo at 210 to a substantially constant voltage of about 34 volts and the voltage swing of switching voltage Vsw at 216 remains constant. Also, feedback circuit 48 and feedback transistor 144 provide a substantially constant feedback current Ifb at 56 and maintain a constant load current Il at 214 of 20 mA.

If load current Il at 216 is shorted to a low voltage, such as ground, driver voltage Vd at 58 forward biases the base-collector junction of transistor 144. Current flows through the base-collector junction of transistor 144 and resistor 140 to ground, which clamps driver voltage Vd at 58 to a voltage that prevents push/pull charge pump circuit 82 from switching and pumping output voltage Vo at 210 to a higher voltage value. With output voltage Vo at 210 less than or equal to the application/system power supply voltage V at 208, enable circuit 46 disables output current Io at 56, such that output current Io at 56 and load current Il at 214 are 0 mA.

Power supply circuit 40 (shown in FIG. 2) is a transistor based circuit that does not require a complex controller and reduces costs. Voltage pumping and current regulation are part of the same circuit. Also, power supply circuit 40 is energy efficient circuit. Power supply circuit 40 pumps output voltage Vo at 210 just enough to provide load current Il at 214, avoiding extra power loss due to large voltage drops. If the application/system power supply voltage V at 208 exceeds the driver voltage of load 42, power supply circuit 40 settles into a mode that includes minimal pumping of output voltage Vo at 210. Also, if load current Il at 214 is shorted to a low voltage, such as ground, power supply circuit 40 shuts down, eliminating the possibility of additional circuit/system damage. In addition, power supply circuit 40 operates without sharp signal transitions, which reduces EMC implications.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is Claimed is:

1. A system comprising:
a first circuit that receives a supply voltage and a timer signal and is configured to provide an output voltage that is greater than the supply voltage;
a second circuit that receives the output voltage and enables an output current if the output voltage is sufficiently greater than the supply voltage; and
a third circuit that detects the output current and is configured to provide a load current and a feedback current in response to the output current, wherein the first circuit receives the feedback current and a feedback loop including the first circuit and the second circuit and the third circuit regulates the output voltage and the load current via the feedback current.

2. The system of claim 1, wherein the third circuit increases the feedback current in response to an increase in the output current and the third circuit decreases the feedback current in response to a decrease in the output current.

3. The system of claim 1, wherein the second circuit includes a transistor and the third circuit is coupled to a diode stack that receives the load current and if the drive voltage of the diode stack is sufficiently less than the supply voltage the first circuit pumps the output voltage to a voltage value that biases the transistor into the active region and enables the output current.

4. The system of claim 1, wherein the second circuit includes a transistor and the third circuit is coupled to a diode stack that receives the load current and if the drive voltage of the diode stack is greater than the supply voltage the first circuit pumps the output voltage to a voltage value that saturates the transistor and enables the output current.

5. The system of claim 1, wherein the third circuit provides a substantially constant load current.

6. The system of claim 1, wherein the third circuit prevents the first circuit from providing an output voltage that is greater than the supply voltage if the load current is shorted to ground.

7. The system of claim 1, wherein the second circuit comprises a transistor having a junction between a first terminal that receives the output voltage and a second terminal that is coupled to the supply voltage, such that the transistor is biased on when the output voltage forward biases the junction.

8. The system of claim 7, wherein the transistor has a third terminal and the third circuit receives the output current from the third terminal.

9. The system of claim 1, wherein the third circuit includes a transistor that detects the output current and provides the feedback current to the first circuit in the feedback loop that regulates the output voltage and the output current.

10. The system of claim 1, wherein the first circuit comprises:
a charge pump driver circuit that receives the timer signal; and
a push/pull charge pump that is activated by the charge pump driver circuit if the timer signal is clocked.

11. A circuit comprising:
a charge pump circuit that receives a supply voltage and a timer signal and is configured to provide an output voltage that is greater than the supply voltage;
a first transistor biased on and off by the output voltage and the supply voltage and configured to provide an output current if biased on;
a second transistor biased on and off by the output current and configured to provide a feedback current if biased on, wherein the output current includes the feedback current and a load current and the charge pump circuit receives the feedback current in a feedback loop that includes the charge pump circuit and the first transistor and the second transistor and that regulates the output voltage and the load current via the feedback current.

12. The circuit of claim 11, comprising:
a first resistor; and
a second resistor, wherein the first transistor has a first terminal that receives the output voltage, a second terminal coupled to the output voltage via the first resistor and coupled to the supply voltage via the second resistor, and a third terminal that provides the output current in response to the output voltage being sufficiently greater than the supply voltage.

13. The circuit of claim 12, comprising:
a third resistor; and
a fourth resistor, wherein the second transistor has a fourth terminal that receives the output current, a fifth terminal coupled to the fourth terminal via the third resistor and coupled to the fourth resistor that provides the load current, and a sixth terminal that provides the feedback current.

14. The circuit of claim 11, wherein the second transistor clamps a switching voltage low in the charge pump circuit if the load current is shorted to a low voltage.

15. A method, comprising:
receiving a supply voltage and a timer signal at a first circuit;
providing an output voltage that is greater than the supply voltage via the first circuit;
receiving the output voltage at a second circuit;
enabling an output current if the output voltage is sufficiently greater than the supply voltage;
detecting the output current at a third circuit;
providing a load current and a feedback current in response to the output current via the third circuit;
receiving the feedback current at the first circuit; and
regulating the output voltage and the load current via the feedback current.

16. The method of claim 15, comprising:
increasing the feedback current in response to an increase in the output current; and
decreasing the feedback current in response to a decrease in the output current.

17. The method of claim 15, comprising:
receiving the load current at a diode stack; and
pumping the output voltage to a voltage value that biases a transistor in the second circuit into the active region and enables the output current if the drive voltage of the diode stack is less than the supply voltage.

18. The method of claim 15, comprising:
receiving the load current at a diode stack; and
pumping the output voltage to a voltage value that biases a transistor in the second circuit into saturation and enables the output current if the drive voltage of the diode stack is greater than the supply voltage.

19. The method of claim 15, comprising:
clamping a switching voltage low in the first circuit if the load current is shorted to ground.

20. The method of claim 15, comprising:
receiving the timer signal at a charge pump driver circuit;
clocking the timer signal; and
activating a push/pull charge pump via the charge pump driver circuit.
